(19) United States
(12) Patent Application Publication
(10) Pub. No.: US 2010/0138306 A1
(43) Pub. Date: Jun. 3, 2010

(54) Method of Promotion and Advertisement Via the Background of a Website

(75) Inventor: Eliason James, West Des Moines, IA (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(73) Assignee: TWITTAD, LLC, Urbandale, IA (US)

(21) Appl. No.: 12/547,336

(22) Filed: Aug. 25, 2009

Related U.S. Application Data
(60) Provisional application No. 61/091,649, filed on Aug. 25, 2008.

(51) Int. Cl. G06Q 30/00

(52) U.S. Cl. 705/14.69; 705/14.73

(57) ABSTRACT

A method for bloggers or social network users to monetize their use of these websites is presented. A social network website user can sell use of their website's background space or status updates to advertisers, which generates revenue for the website user.

This application claims priority to U.S. Patent Application No. 61/091,649 and herein incorporates U.S. Patent Application No. 61/091,649 by reference.

### BACKGROUND OF THE INVENTION

1. Field of the Invention

The present invention relates in general to a method of promotion and advertisement on a website. In particular, the present invention relates to a method for bloggers or social network users to monetize their use of these websites.

2. Background

The Internet is a well-known medium for delivery of a nearly endless variety of information, including the promotion and sales of goods and services. Virtually all businesses utilize the Internet in one form or another for this purpose, which allows them to reach a potentially large audience. In conjunction with the growth of the Internet based commerce, there has been a similar proliferation of techniques and technology designed to generate revenue through the advertising and promotion of goods and services on the websites of others.

Blogging and social networks websites have also exploded in popularity. Updates to a person's blog or social networking page are displayed on the user's profile page, along with information about the blogger or user, photos, videos, music, etc. In this patent application, the social networking and micro-blogging service Twitter is used as an example, although the invention is not limited to Twitter uses or even to blogging or social networking sites in general. Other examples of blogging or social networking sites that would support this system include but are not limited to myspace, Facebook, or LinkedIn. By way of example, Twitter includes a status update or microblogging service that enables its users to send and read messages known as Tweet. Tweets are text-based posts of a limited number of characters displayed on the author's profile page and delivered to the author's subscribers, or followers. Twitter users can send and receive tweets via the Twitter website, Short Message Service, (SMS) or external applications (for example, tweets can be sent to followers' cell phones).

These sites do not include an option for publishing advertisements on an individual user's page or through status updates. This invention was created to give these sites' users and advertisers the opportunity to meet for product placement and website promotion, and to generate advertisement revenue for the website user.

Other examples of methods of generating revenue via website advertisement include the system described in U.S. patent application Ser. No. 12/241,025, which describes a system for auctioning off advertising space around a web-based video. Application Ser. No. 12/241,025 is herein incorporated by reference in its entirety.

### SUMMARY OF THE INVENTION

The present invention is directed to a method of connecting advertisers and website users and generating revenue for website users from use of their websites.

Accordingly, it is an object of the present invention to provide a system for advertisement on a website.

It is a further object of the invention to provide a system for generating revenue to bloggers and social network website users.

Another object of the present invention is to provide a system for advertising on the background of blogs or social network user pages and/or in status updates.

### BRIEF DESCRIPTION OF THE DRAWINGS

FIGS. 1-10 are exemplary screen shots of the type that may be utilized in one embodiment of the method and system of the present invention.

### DETAILED DESCRIPTION OF THE INVENTION

### Method Overview

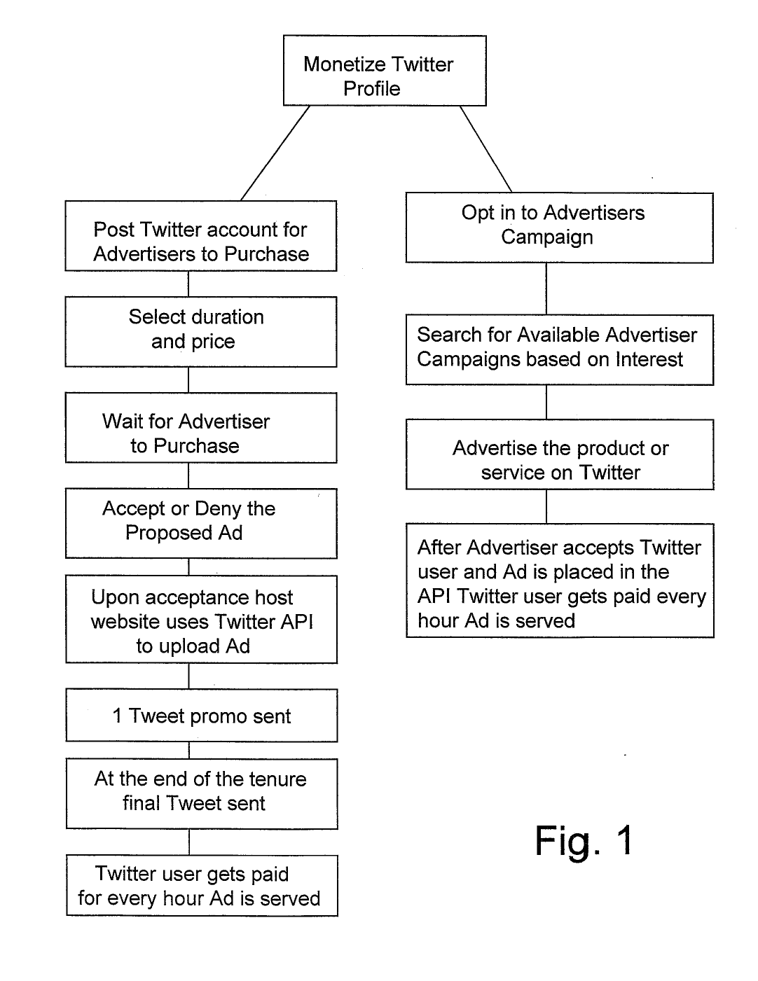

As seen generally in FIGS. 1-10, the present invention is a method 10 of generating advertising revenue for a social network user or a blogger. A host website 12 is typically provided that includes several options for connecting users 14 and advertisers 16, as shown in FIG. 1.

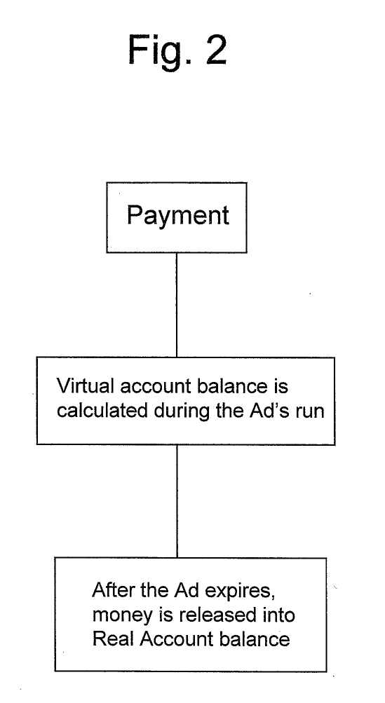

By way of example, connection of advertisers 16 and Twitter users 14 are described. In FIG. 2, a Twitter user 14 can change the background 20 of their Twitter page 21. This design 20 can include advertisements 22, if the user desires. In one embodiment, the advertisements 22 are not clickable when appearing on the background 20 of a user's page; the advertisement 22 contains information regarding how to contact the advertiser 16, and/or the advertiser's 16 own Internet site. In another embodiment, the background is coded in HTML, which allows click-through advertisements that directly link a consumer to the advertiser via the Twitter user's 14 page.

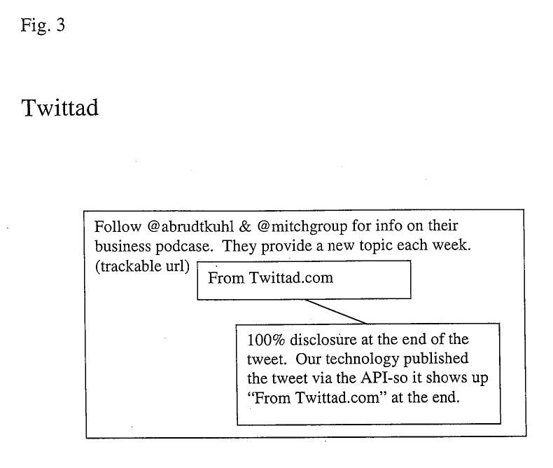

The Twitter user 14 also provides status updates 24, known as Tweets. The advertisement 22 (either in its entirety or a simple indication that the user's page is sponsored by the advertiser) may appear in a status update 24 that is sent to all of the users followers and is posted on the user's Twitter page, as seen in FIG. 3.

A user can generate revenue 26 by selling off advertisement space (the background 20 and/or status updates 24 (Tweets)) of the user's page. A Twitter user 14 who wants to provide advertisements on the user's 14 Twitter page posts the Twitter account for advertisers 16 to purchase. The user 14 selects the duration of the advertisement and sets the price of that advertisement space. An interested advertiser 16 submits the advertisement to the Twitter user 14 for the user's approval. The advertisement 22, if selected, appears as the background of the Twitter page. If the user accepts, the user then uploads the background, with the advertisement 22 to the user's page. The user also posts the agreed upon status updates.

The Twitter user 14 receives the payment 26 from the advertiser 16. A percentage of the set price, or a minimum fee is paid to the website 12 that connects the users with the advertisers.

Because there is no guarantee that the user 14 will keep the background with the advertisement 22 up for the entire agreed-upon duration, the user 14 does not receive payment until the time has expired. In one embodiment, the website 12 that connects the advertisers and users monitors the amount of time that the advertisement is posted, and will only pay the user for the percentage of time that the advertisement actually appears on the user's page. For example, the host website 12 may monitor the user's page incrementally (for example, every hour) to make sure that the user is posting the ad. Every hour that the advertisement 22 is posted, the user receives money in the host account. If the advertisement 22 is removed prematurely, the user receives money prorated for the actual time posted. Further, advertisers 16 can provide negative feedback that will be available on the host page. Thus, if a user 14 removes an advertisement prematurely, the advertiser 16 can leave feedback associated with that user that may prevent other advertisers from buying the background of that Twitter user.

Once the advertisement 22 has expired, the user can resubmit the profile page for another purchase on host website.

The host website 12 provides background 20 templates and sizing suggestions for the advertisements. Typically, the advertisement 22 appears down one side of the user's page on the social networking site or blog, with the user's own material appearing prominently in the middle of the page. The background 20 colors can be altered by the advertiser in accordance with the advertiser's branding. Other tools that the host website 12 provides may include a URL shortener 40that shortens the advertiser's URL to be included within a status update or Tweet. This tool can also provide the advertiser 16 with information on number of clicks, location of person clicking through, etc.

Monetizing a Twitter Profile

Advertisers 16 and Twitter users 14 are connected in these example. Twitter users 14 monetize their Twitter profiles and advertisers 16 reach Twitter followers. In general, a host website 12 provides advertisers 16 and social network users/bloggers 14 with host-site profiles 30, 32. The advertisers 16 may include information in their host-site profiles 32 such as sample advertisements, targeted audiences, categories, price the advertiser 16 is willing to pay a social network user to run the ad, duration of the ad, maximum number of users that can run the campaign, number of followers that a user is required to have to run the campaign, etc. The users 14 may include information in their profiles 30 including demographics (age, sex, location, etc.), profession, interests, categories, amount they would be willing to receive for use of their page and/or status update, duration of campaign they would be willing to run, etc.

### Option 1: A Twitter User Posts their Twitter Account for Advertisers to Purchase

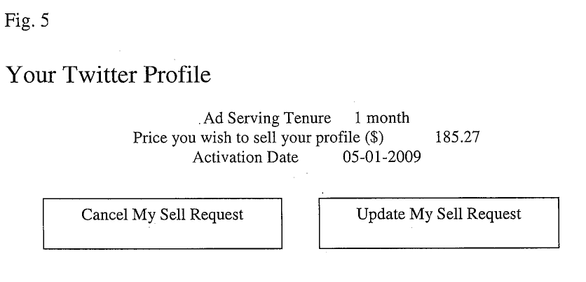

A Twitter user 14 posts his Twitter account for advertisers 16 to purchase on a host website 12. The Twitter user 14 identifies a time period for the ad campaign to run (typically 1 day, 3 days, one week, one month, or three months) and a price, as shown in FIG. 5. An advertiser 16 then purchases the opportunity to run an ad on that Twitter user's 14 account. The advertisement 22 typically appears on the background of the Twitter user's webpage, and in a Tweet (status update) that publishes at least once during the duration of the ad campaign. It is also possible for the advertisement 22 to just appear in the background of the Twitter user's 14 page or in a status update.

In one embodiment there is a waiting period (usually 48 hours) after the advertiser 16 and Twitter user 14 are connected before the advertisement campaign runs, during which time the Twitter user can reject the advertiser. If the Twitter user 14 accepts the advertisement, the advertisement 22 will run for the agreed-upon time period with the agreed-upon number and timing of sponsored status updates. In one example, a sponsored Tweet is sent at the beginning, middle, and end of the campaign.

The Twitter user 14 receives the agreed-upon sales price 26 for the space if the campaign is run for the entire period, and receives a prorated amount if the advertisement was removed prematurely. The host site 12 may also collect a transaction or service fee.

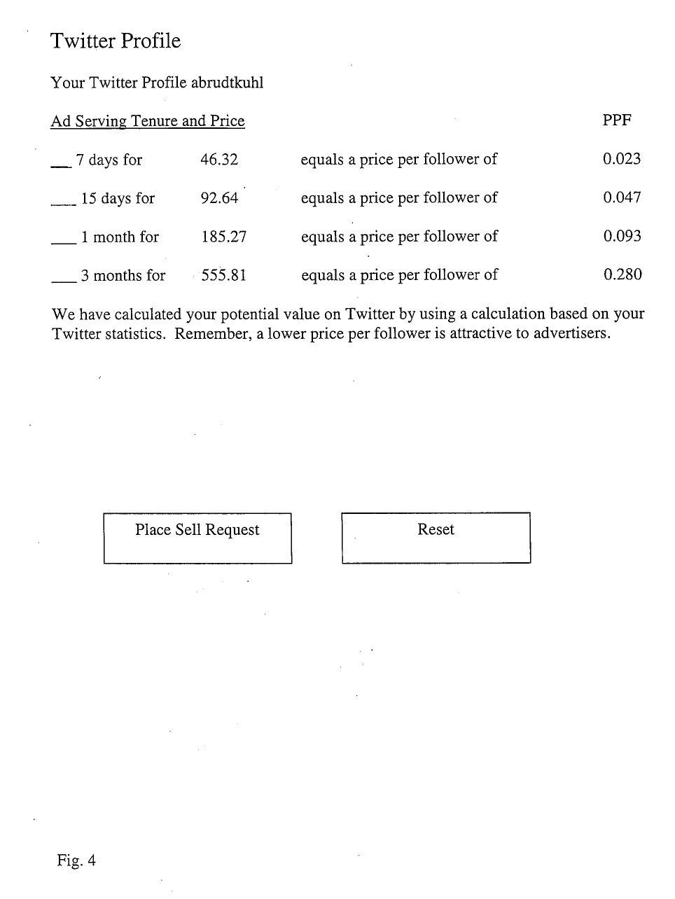

In FIG. 4, the host site 12 may assist a user in setting a price for use of their page. Considerations in determining price may include the number of followers or followings a particular user has, length of time the user has been a member of the social networking site, frequency of status updates, etc. In one example, the host 12 calculates a Price Per Follower (PPF) 34 value by taking into consideration these and other criteria. The PPF value 34 may be posted on the user's host-based profile 30.

### Example 2

### Opt-In Campaign

In this example, a Twitter user 14 searches for available advertiser 16 campaigns. The Twitter user 14 can search based on his or her interests. For example, if the Twitter user 14 is a small business owner, the user can seek out advertisers who sell products that the user uses in her business.

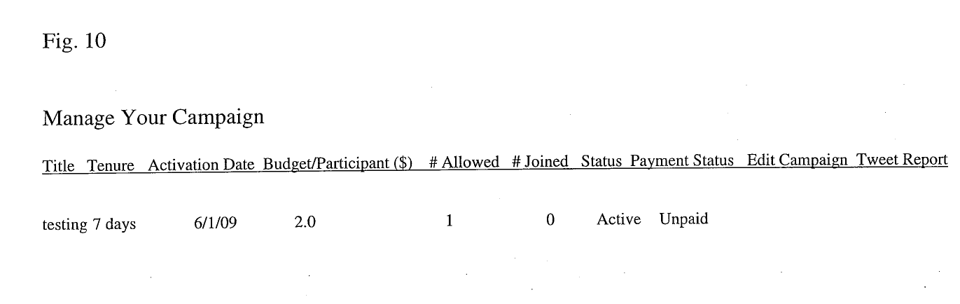

Typically an advertiser 16 will post an advertisement 22 campaign in its profile on the host site for Twitter users to opt into. The advertiser's opt-in campaign 42 will describe the criteria required for a Twitter user to be eligible to run the campaign, as seen in FIG. 10. For example, the advertiser 16 may post a campaign 42 indicating that the advertiser will pay any Twitter user with over 500 followers a fee of $2.50 to advertise a product for seven days. The advertisers 16 can include keywords in their campaign description to target Twitter users with an interest in those categories or keywords. The advertisers 16 can limit the number of Twitter user that opt into the campaign, or set a budget per participant.

The host website 12 can also allow advertisers 16 to search for local Twitter users 14. For example, if an advertiser 16 is a local restaurant that wants to place ads on Twitter user 14 pages that are from the same area, the advertiser can search Twitter users 14 for local users and the advertiser can target those specific Twitter users 14.

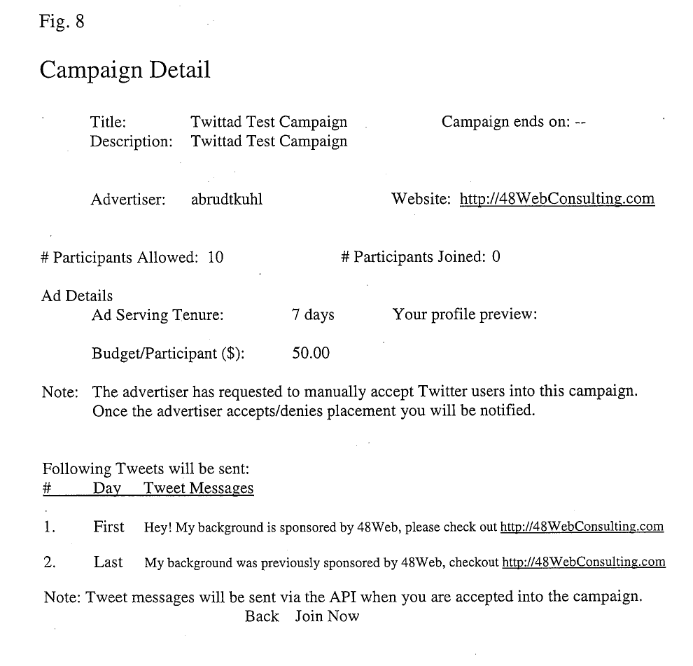

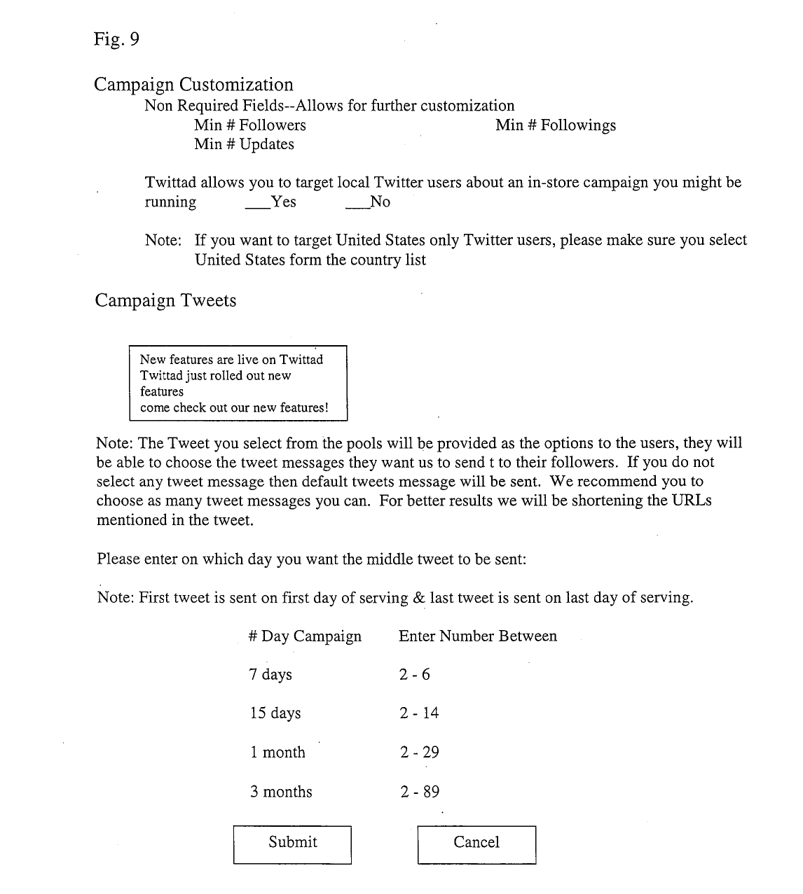

As shown in FIGS. 8-9, the advertiser 16 can include several advertisement options 22 for the user to select from, including different background advertisements or status updates. Further, the advertisements 22 that appear in the status updates 24 can include links. When an interested person clicks on the link, they will be taken to either the advertiser's own webpage, or a page hosted by the host site providing the advertiser's specific advertisement.

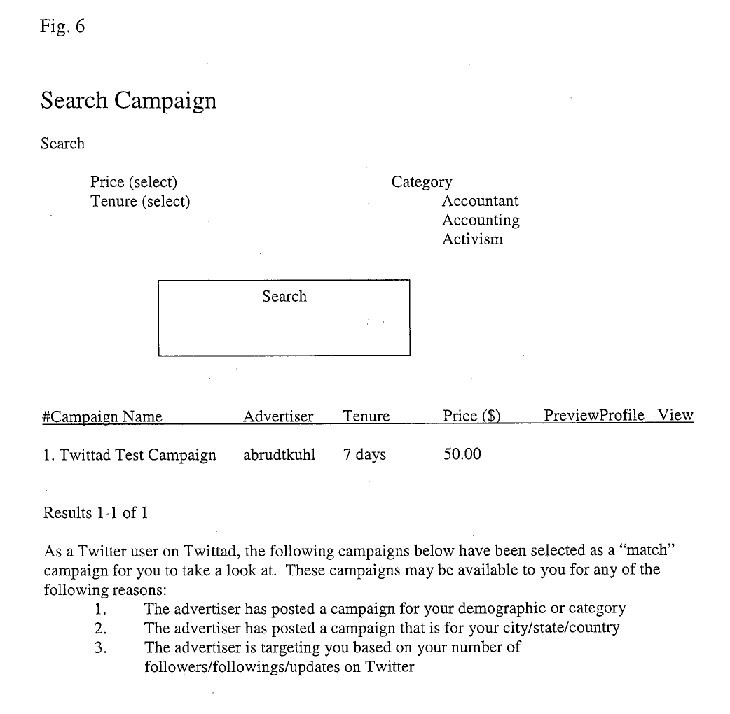

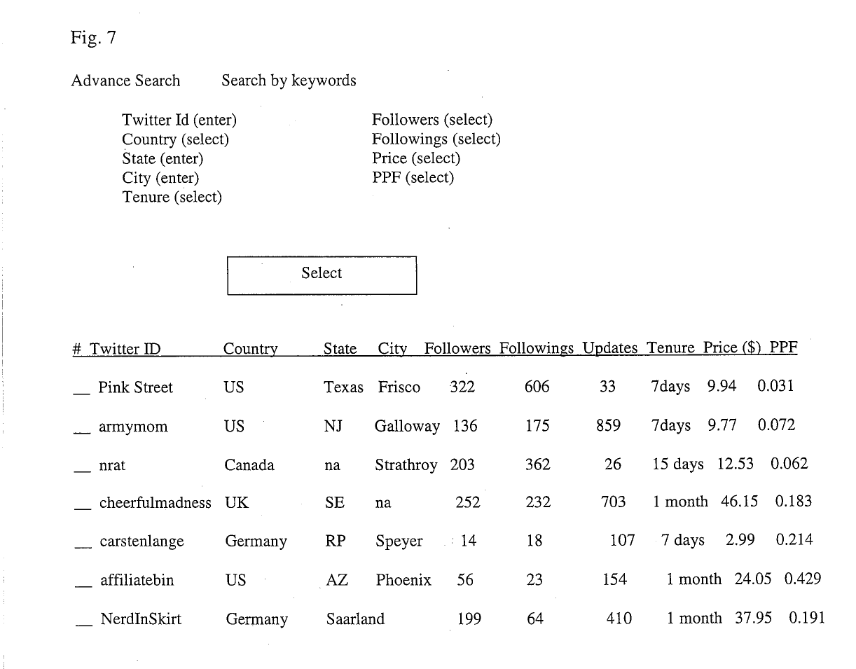

In FIGS. 6-7, the host site 12 can assist in connecting users 14 and advertisers 16 in several ways. A Twitter user 14 can indicate in his host-based profile different types, categories, or other qualifications of advertisements that he would be interest in running on his Twitter account. The host site 12 can contact Twitter users 14 when an advertiser's 16 opt-in campaign has been posted that meets the selections or criteria of the Twitter user, as shown in FIG. 6. For example, the host site may contact a Twitter user to let them know that an advertiser has posted a campaign for his demographic, category, number of followers, number of followings, or updates on Twitter. This also works in the reverse such that the host can provide advertisers with information about Twitter users who match the requirements of the advertisers. Further, advertisers and users can search each others' profiles. Searchable criteria may include demographic information, interests, keywords, product descriptions, profession, business type, duration of ads, and price.

After the opt-in campaign has run, the Twitter user 14 is paid the price 26 posted by the advertiser. The host site 12 may also collect a transaction or service fee.

While this invention has been described as being used with Twitter, the invention also works with any website that allows a user to change the background. For example, the invention would also be compatible with many blogs, myspace.com, Facebook, and LinkedIn.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention. This system works with any website that has an application programming interface (API) that is released to the public, licensed, or otherwise made available.

1. A method for providing advertising revenue to a website user, comprising:
a) providing a user content based website, wherein the website includes at least one advertising space and the website is maintained by a user;
b) providing an advertiser;
c) connecting the advertiser with the content-based website user; and
d) generating returns to the content-based website user for sales of the advertising space.

2. The method of claim 1, wherein the advertising space is the background of the user's website.

3. The method of claim 1, wherein the advertising space is a status update.

4. A method of advertising on a website comprising:
a) providing a host website;
b) connecting an advertiser and a content-based website user, wherein the content-based website user's website includes advertising space; and
c) running advertiser's advertisements on the content-based user's website.

5. The method of claim 4 further comprising the step of generating returns to the content-based website user for sales of the advertising space.
